(19) United States
(12) Patent Application Publication
(10) Pub. No.: US 2016/0142654 A1
(43) Pub. Date: May 19, 2016

(54) On-chip Integrated Hyperspectral or Multispectral Imaging System

(71) Applicant: Jarrod Vaillancourt, Rindge, NH (US)

(72) Inventor: Jarrod Vaillancourt, Rindge, NH (US)

(73) Assignee: Applied NanoFemto Technolgies LLC, Lowell, MA (US)

(21) Appl. No.: 14/940,263

(22) Filed: Nov. 13, 2015

Related U.S. Application Data
(60) Provisional application No. 62/079,244, filed on Nov. 13, 2014.

(51) Int. Cl. H04N 5/335; G02B 5/00; G02B 5/20; G06T 7/40

(52) U.S. Cl. CPC H04N 5/335; G06T 7/403; G02B 5/008; G02B 5/208; G02B 5/204; G06T 2207/10036; G06T 2207/10048

(57) ABSTRACT

Methods and systems for on-chip hyperspectral or multispectral imaging are disclosed, including providing an imaging system comprising one or more detectors; plasmonic hyperspectral or multispectral filters integrated onto each pixel of the IR FPA; and electrical interconnections to the IR FPA; and exposing the imaging system to electromagnetic radiation reflected from an area and using the imaging system to generate a hyperspectral image of the area. Other embodiments are described and claimed.

### CROSS REFERENCE TO RELATED APPLICATIONS

This application claims the benefit of the filing date of U.S. Provisional Patent Application Ser. No. 62/079,244, filed on Nov. 13, 2014, entitled “Surface Plasmonic Resonance Enabled Hyperspectral Imaging Systems,” the entire disclosure of which is hereby incorporated by reference into the present disclosure.

### STATEMENT REGARDING FEDERALLY SPONSORED RESEARCH

The U.S. Government has a paid-up license in this invention and the right in limited circumstances to require the patent owner to license others on reasonable terms as provided for by the terms of the contract NNX14CG53P awarded by NASA SBIR program.

### BACKGROUND

The invention relates generally to the field of hyperspectral or multispectral imaging systems. More particularly, the invention relates to compact on-chip integrated hyperspectral or multispectral imaging systems with pixel-wise integrated plasmonic filters for spectral filtering.

### SUMMARY

In one respect, disclosed is an on-chip hyperspectral or multispectral imaging system comprising: infrared (IR) imaging focal plane array (FPA); a plasmonic hyperspectral filter integrated onto each pixel of the FPA; an aperture; and an objective lens to collect and focus the infrared radiation onto the on-chip hyperspectral or multispectral IR FPA.

In another respect, disclosed is a hyperspectral or multispectral imaging system comprising: an IR FPA, wherein the FPA comprises IR photodetectors and wherein the photodetectors can be any kind of photodetectors with the detection wavelengths at any region between 0.8 microns to about 14 microns; a plasmonic hyperspectral or multispectral filter integrated onto each pixel of the IR FPA, wherein each of the plasmonic hyperspectral filter comprises a metallic thin slab with a periodic lattice of holes, wherein the holes of the periodic lattice of holes extend through the metallic slab substantially normal to the slab surface, wherein the metallic thin slab comprises gold, silver, copper, aluminum, nickel, or other similar metal, wherein the thickness of the metallic thin slab ranges from about 10 nm to about 100 nm, wherein the periodic lattice of holes comprises a period ranging from about 0.5 μm to about 4 μm, and wherein the holes of the periodic lattice of holes comprises a diameter ranging from about 0.25 μm to about 2 μm; an aperture; and an objective lens to collect and focus the infrared radiation onto the IR FPA. A metallic ground plane on the back side of the IR FPA can be added to the metallic thin slab and form the plasmonic filter cavity to obtain narrow spectral band.

In another respect, disclosed is a method for on-chip hyperspectral or multispectral imaging comprising: providing an imaging system comprising an IR FPA; a plasmonic filter integrated to each pixel of the IR FPA; and electrical interconnections to the IR FPA; and exposing the imaging system to electromagnetic radiation from an area and using the imaging system to generate a hyperspectral or multispectral image of the area.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a schematic illustration of passive satellite optical remote sensing, in accordance with some embodiments.

FIG. 2 is a schematic of a hyperspectral imaging system where an ultra-compact hyperspectral IR imaging system may be utilized, in accordance with some embodiments to eliminate the diffraction grating and thus offering a compact integrated hyperspectral system with high reliability.

FIG. 3 a schematic of the compact on-chip integrated hyperspectral or multispectral IR imaging system enabled by the surface plasmonic resonance filters, in accordance with some embodiments.

FIG. 4 illustrates a perspective view of a part (four pixels) of the FPA with one plasmonic filter of specific sensing wavelength on each pixel, in accordance with some embodiments.

FIG. 5 is a graph showing simulated transmission profiles of the two-dimensional subwavelength hole array for periods between 2.3 μm and 3.2 μm in increments of 0.1 μm, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

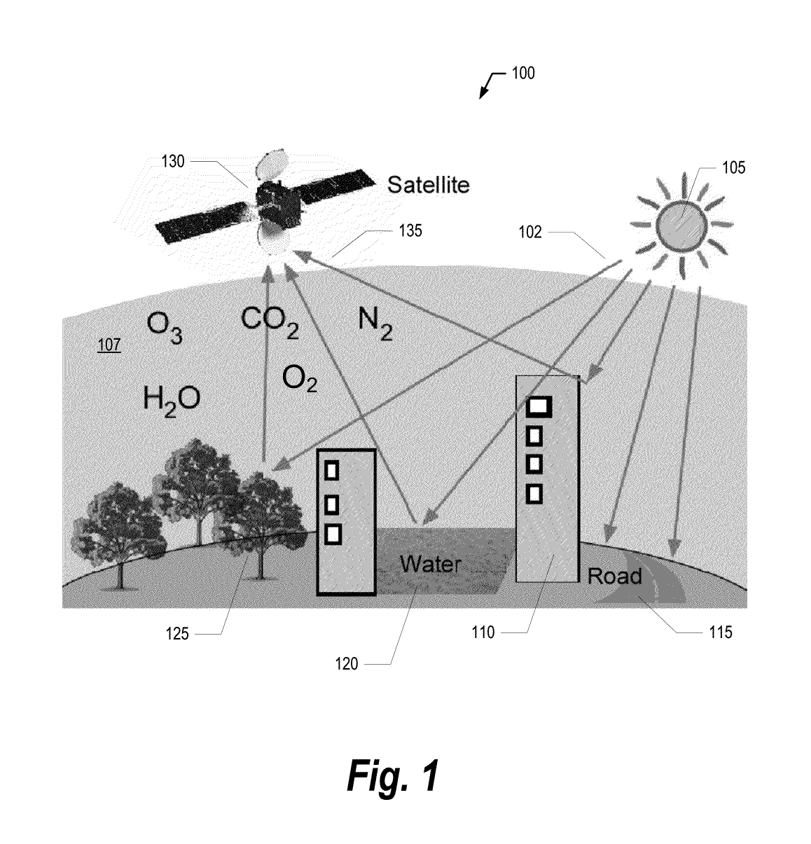

FIG. 1 is a schematic illustration of passive satellite optical remote sensing, in accordance with some embodiments.

Optical remote sensing systems on Earth observing satellites measure the reflection and/or radiation characteristics of light from the Earth's surface and atmosphere. Such measurements provide critical information of the Earth's resources and its environment, including monitoring accessible freshwater, terrestrial and aquatic ecosystems and their degradation, overseeing and recording the changes in the chemistry of the atmosphere, such as carbon-based trace gases, CH₄, and CO₂, mapping of the Ozone (O₃) layer, and collecting air pollution data and relating them to human activities. These measurements play key roles in NASA's Earth observation mission in understanding of the Earth system and its response to natural and human-induced changes. FIG. 1 illustrates the principle of passive, Earth optical remote sensing 100. Electromagnetic radiation from space 102, i.e. from the Sun 105, passes through the Earth's atmosphere 107 comprising nitrogen (N₂), oxygen (O₂), ozone (O₃), carbon-dioxide (CO₂), and water (H₂O) among other molecules and strikes the Earth's surface. Different objects on Earth, such as buildings 110, roads 115, bodies of water 120, and trees 125 reflect some of the electromagnetic radiation back through Earth's atmosphere and into space. An Earth observing satellite 130 equipped with optical sensors collects some of the reflected electromagnetic radiation 135. The sensors measure the radiation and absorption spectra, and based on the spectral information, analyze the chemical components and their concentrations. Table I lists the absorption peak wavelengths of different gas molecules in the middle-wave infrared (MWIR, 3-5 μm) and longwave infrared (LWIR, 8-14 μm) spectral regions along with their relative transparency and brightness in the sky.

TABLE I
Absorption peak wavelength of gas molecules.

| | Absorption | | Sky | Sky |
|---|---|---|---|---|
| Molecules | Wavelength | Band | Transparency | Brightness |
| CH₄ | 3.4 μm | J (3.0-4.0 μm) | High | Low |
| CO₂ | 4.3 μm | N/A | Low | High |
| CO | 4.7 μm | K (4.6-5.0 μm) | Low | High |
| NO | 5.3 μm | K | Low | High |
| O₃ | 4.7 μm | J | Low | High |
| (four | 7.4 μm | N/A | High | Low |
| absorption | 9.6 μm | M | High | Low |
| bands) | 11.4 μm | N | High | Low |

Satellite based hyperspectral infrared (IR) imaging can provide hundreds of narrow band (10-15 nm) spectral images of Earth's surface and the atmosphere over the MWIR and the LWIR spectral ranges. Such hyperspectral imaging not only enables optical remote sensing of the trace gas species (CH₄, CO₂, CO, and O₃) in Table I with high spectral resolution, but also allows for precise surface material identification (i.e. vegetation, soil, water, etc.) and high resolution mapping of the atmosphere for pollution monitoring and atmospheric effect corrections.

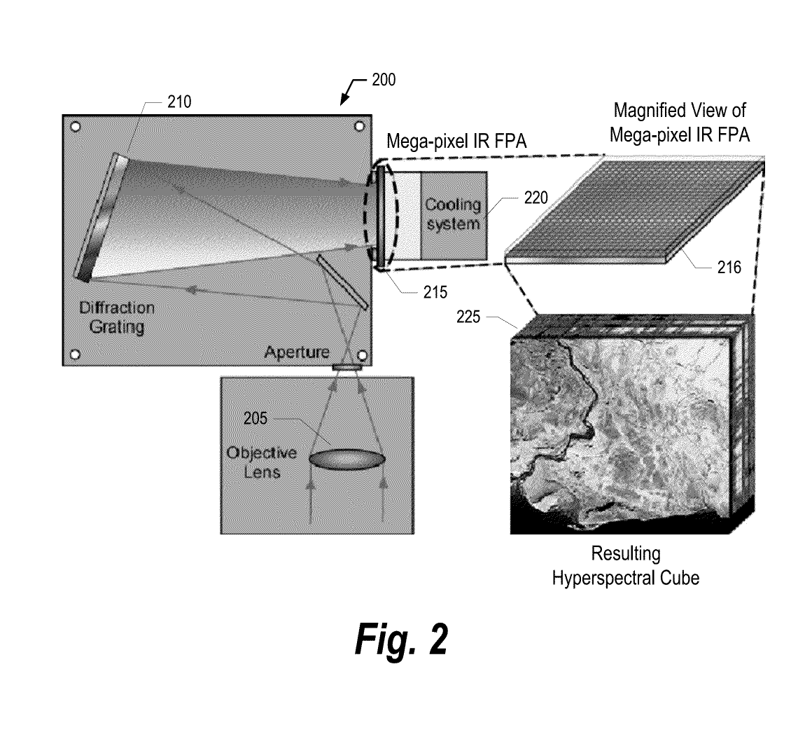

FIG. 2 is a schematic of a hyperspectral imaging system where an ultra-compact hyperspectral IR imaging system may be utilized, in accordance with some embodiments to eliminate the diffraction grating and thus offering a compact integrated hyperspectral system with high reliability.

The hyperspectral IR imaging system 200 comprises an IR light collection objective lens 205, a diffraction grating 210 to disperse IR light to hundreds of narrow bands, and a large-format 1024×1024 (mega-pixel) IR focal plane array (FPA) 215 with its cooling system 220 for hyperspectral imaging. The dashed ellipse around the mega-pixel IR FPA 215 expands to a magnified view of the mega-pixel IR FPA 216. Using such a mega-pixel IR FPA, results in a hyperspectral cube 225 of the scanned or probed area or region. Since the system incorporates a high-resolution dispersive grating and a mega-pixel FPA, the system provides hundreds of spectral bands with sub 10 nm spectral resolution in the MWIR and LWIR spectral ranges. Such high resolution, hyperspectral imaging systems provide an effective and essential tool for Earth's surface imaging and atmosphere monitoring.

Despite the advantages of hyperspectral imaging systems in spectral imaging and their importance in the Earth observation missions, existing hyperspectral imaging systems are too heavy and bulky. This is due to the fact that most existing hyperspectral imaging systems utilize bulky free-space diffraction optics, which requires precise optical alignment and sophisticated mechanical servo-systems to compensate for misalignment caused by motion and vibration during the satellite launch and deployment processes. The bulky free-space diffraction optics, the mechanical misalignment compensation and correction systems significantly increase the weight of the hyperspectral imaging system.

What is needed is a hyperspectral imaging system with significantly reduced size, weight, and power consumption. One such on-chip integrated hyperspectral imaging system with reduced size, weight, and power consumption is disclosed in this patent.

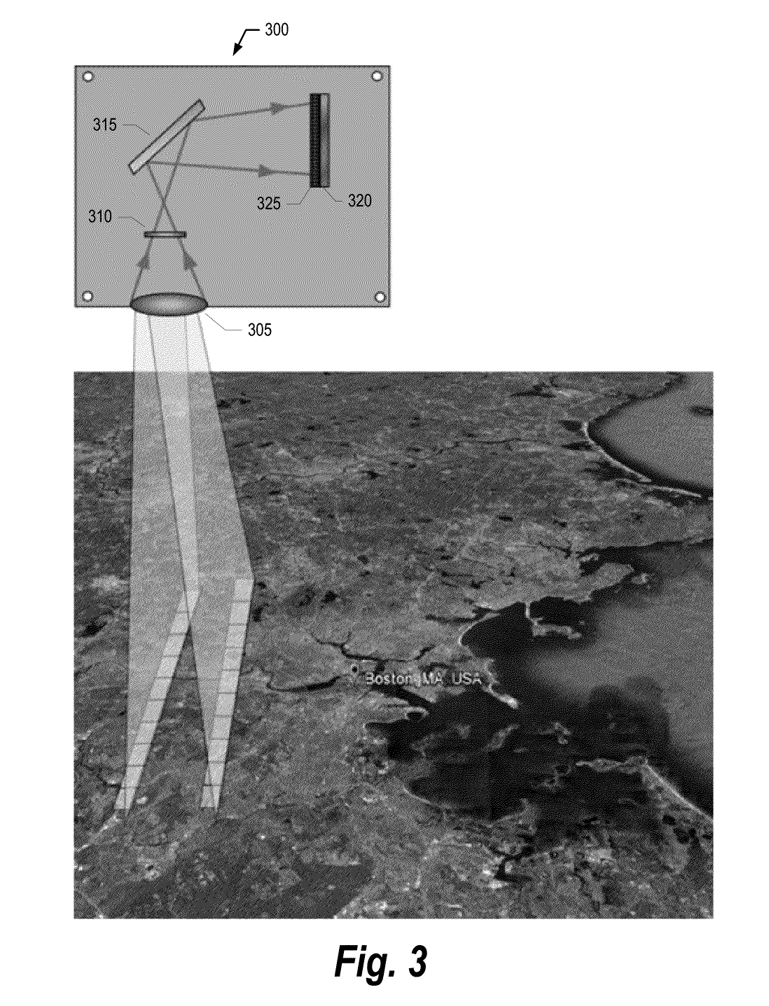

FIG. 3 a schematic of the compact on-chip integrated hyperspectral or multispectral IR imaging system enabled by the surface plasmonic resonance filters, in accordance with some embodiments.

FIG. 3 shows the schematic of the miniature, reduced size, weight, and power consumption, on-chip integrated hyperspectral imaging system 300. The miniature hyperspectral imaging system comprises an objective lens 305, an aperture 310, a scanning mirror 315, and a IR FPA 320 with an integrated plasmonic hyperspectral or multispectral filter 325 on each pixel of the FPA 320. In some embodiments, the scanning mirror 315 is not used and the image of the scanned area is directed to the FPA directly. The FPA may comprise an array of photodetectors or thermal detectors. The miniature hyperspectral imaging system utilizes the integrated plasmonic filter 325 to achieve pixel-wise hyperspectral or multispectral filtering. By not using the diffraction grating based, free-space spectral dispersion optics, it is possible to significantly reduce the size and weight of the hyperspectral or multispectral imaging system. In addition, the integrated detector and the plasmonic hyperspectral or multispectral filter structure is insensitive to motion and vibration and thus greatly improves the reliability of the system. In some embodiments, the plasmonic hyperspectral or multispectral filter comprises a plasmonic spectral filter. Using the plasmonic spectral filter enables on-chip integrated spectral filtering on IR FPAs without the need for any free-space diffraction optics. Additionally, the plasmonic spectral filter maintains precise optical alignment without the need for sophisticated mechanical misalignment correction systems, thus significantly reducing the size and weight of the system as well as improving its reliability.

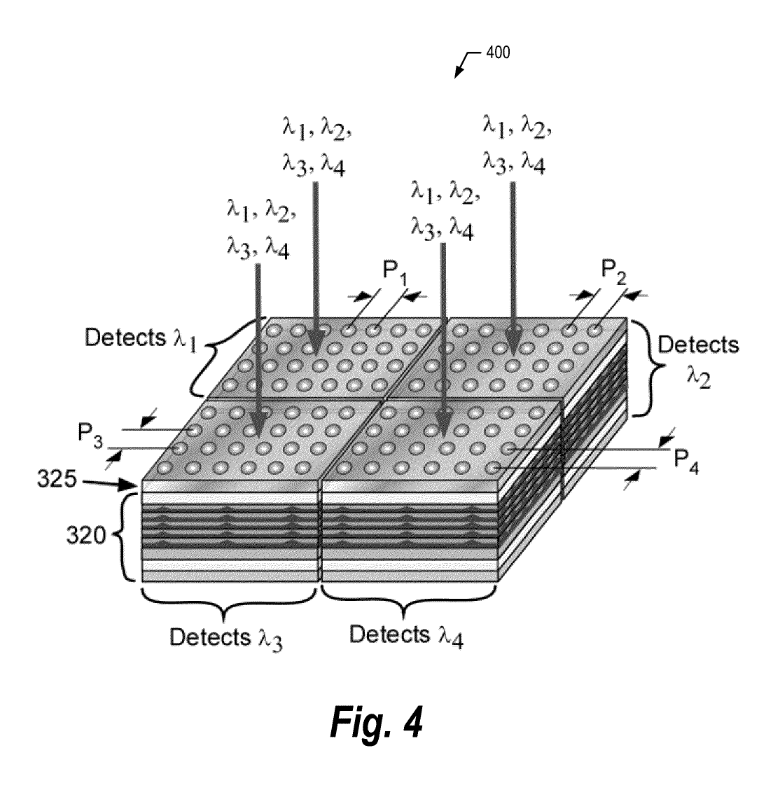

FIG. 4 illustrates a perspective view of a part (four pixels) of the FPA with one plasmonic filter of specific sensing wavelength on each pixel, in accordance with some embodiments.

In some embodiments, the IR FPA 320 comprises an array of infrared photodetectors with an integrated plasmonic hyperspectral filter 325. FIG. 4 illustrates a 2×2 array of IR photodetectors with integrated plasmonic filters. The plasmonic filter may comprise gold, silver, copper, aluminum, nickel, or other similar metal. It is possible to tune the transmission spectral band for each pixel, thus achieving pixel-wise spectral filtering for hyperspectral sensing. The 2×2 array of FIG. 4 is referred to as a super-pixel 400. The IR FPA 320 with integrated plasmonic hyperspectral filter 325 of FIG. 3 is comprised of an array of super-pixels 400. In some embodiments, the plasmonic filters of the super-pixel are tuned to the same transmission spectral band. Additionally, the super-pixel may be any n×n size, where n is an integer greater than 1. The super-pixel may comprise up to n² unique transmission spectral bands. The 2×2 array of FIG. 4 comprises four different transmission spectral bands, λ₁, λ₂, λ₃, and λ₄. The four different spectral bands are possible by tuning the spacing or period between adjacent subwavelength holes. The pixel which detects the transmission spectral band λ₁ has a period of P₁. The pixel which detects the transmission spectral band λ₂ has a period of P₂. The pixel which detects the transmission spectral band λ₃ has a period of P₃. The pixel which detects the transmission spectral band λ₄ has a period of P₄. Non-square super-pixels are also possible. In that case, the super-pixel may be any n×m size with the ability to detect up to n×m unique transmission spectral bands.

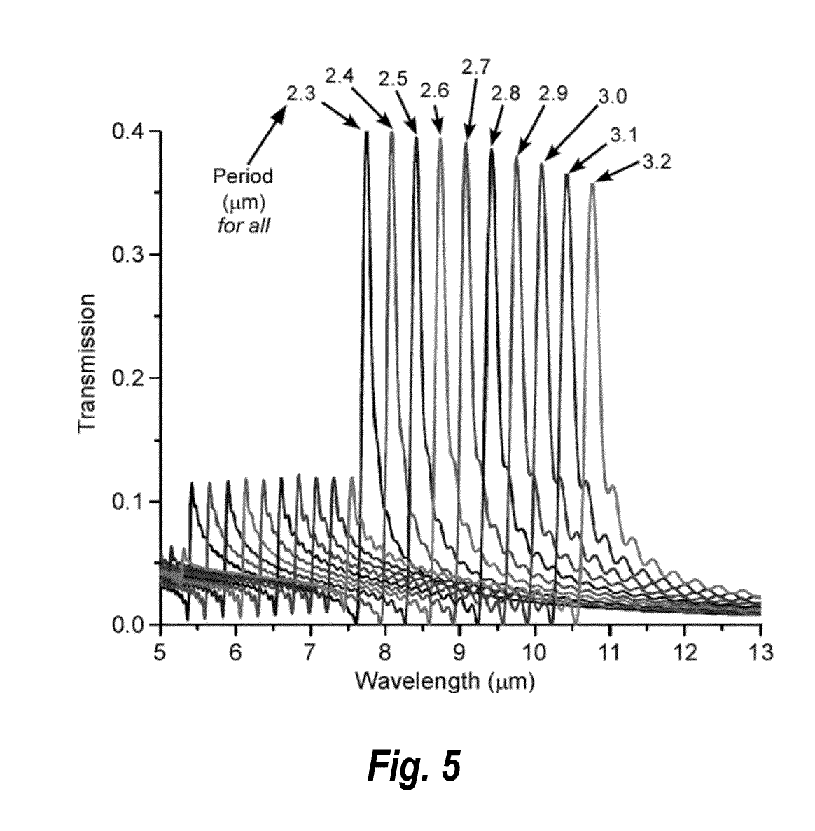

FIG. 5 is a graph showing simulated transmission profiles of the two-dimensional subwavelength hole array for periods between 2.3 μm and 3.2 μm in increments of 0.1 μm, in accordance with some embodiments.

FIG. 5 shows that by varying the period of the hole array in the plasmonic filter, it is possible to shift the resonant peaks. The linear dependence of the SPR wavelengths on the period of the plasmonic structure provides an efficient approach to tune the pass band of the plasmonic filter. In addition, due to the resonant nature of the plasmonic waves, a narrow transmission band (˜15 nm) is obtained. Such narrow band transmission plus the ability to precisely tune the central pass wavelength of the plasmonic filter provides a narrow band filter technology for hyperspectral imaging. Since the surface plasmonic structures are thin, planar structures of only 30 nm, they may be readily fabricated on each pixel of the IR FPA to form a on-chip integrated ultra-compact hyperspectral imaging system with pixel-wise, spectral filtering, i.e. hyperspectral pixels. In addition to the spectral filtering, the plasmonic filter also provides SPR enhancement, enabling pixel-wise hyperspectral sensing with strong SPR enhancement.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. An imaging system comprising:
an IR FPA;
plasmonic hyperspectral or multispectral filters integrated onto each pixel of the IR FPA;
an aperture; and
an objective lens to collect and focus the infrared radiation from an area and onto the IR FPA.

2. The imaging system of claim 1, wherein each of the plasmonic hyperspectral or multispectral filters comprises a metallic thin slab with a periodic lattice of holes, wherein the holes of the periodic lattice of holes extend through the metallic slab substantially normal to the slab surface.

3. The imaging system of claim 2, wherein the plasmonic hyperspectral or multispectral filters further comprise a ground plane on the other side of the IR pixel to form a plasmonic cavity to obtain a narrow spectral band.

4. The imaging system of claim 2, wherein the metallic thin slab comprises at least one of: gold, silver, copper, aluminum, and nickel.

5. The imaging system of claim 2, wherein the thickness of the metallic thin slab ranges from about 10 nm to about 100 nm.

6. The imaging system of claim 2, wherein the periodic lattice of holes comprises a period ranging from about 2 μm to about 4 μm.

7. The imaging system of claim 2, wherein the holes of the periodic lattice of holes comprises a diameter ranging from about 1 μm to about 2 μm.

8. The imaging system of claim 1, wherein the IR FPA comprises infrared photodetectors.

9. The imaging system of claim 1, wherein the IR FPA detects the infrared radiation having a wavelength ranging from about 0.8 microns to about 14 microns.

10. A method for imaging comprising:
providing an imaging system comprising:
one or more detectors;
plasmonic hyperspectral or multispectral filter integrated onto each of the detectors; and
electrical interconnections to the one or more detectors;
exposing the imaging system to electromagnetic radiation from an area; and
using the imaging system to generate a hyperspectral image of the area.
